(19) United States
(12) Patent Application Publication
(10) Pub. No.: US 2004/0203555 A1
(43) Pub. Date: Oct. 14, 2004

(54) Electric wire transmitting facility for network system

(76) Inventor: Jesse Kao, Hsin Chuang City (TW)

Correspondence Address: Jesse, KAO, P.O. Box 4-67, Hsin Chuang, Taipei 242, TW

(21) Appl. No.: 10/253,188

(22) Filed: Sep. 20, 2002

(51) Int. Cl. H04B 5/00; H04M 9/00; H04L 12/28; H04L 12/56

(52) U.S. Cl. 455/402; 370/908; 455/41.1

(57) ABSTRACT

A wire transmitting facility includes a network access device for accessing into network systems, and a transmitting device having an electric power supplier and an electric wire transmitting integrated circuit coupled between an electric power supply and the network access device. The electric power supplier may convert the received electric power to energize both the network access device and the electric wire transmitting integrated circuit. The transmitting integrated circuit includes a coupler for communicating with electric lines of family housings or buildings. via a wire transmitting facility.

The present invention has arisen to mitigate and/or obviate the afore-described disadvantages of the conventional wire transmitting devices for network systems.

### SUMMARY OF THE INVENTION

The primary objective of the present invention is to provide a wire transmitting facility for coupling a WLAN access device to network systems with a single electric power source, and for simplifying the electric wire coupling of the WLAN access device, and for decreasing the manufacturing cost for the wire transmitting facility.

The other objective of the present invention is to provide a wire transmitting facility for allowing two or more WLAN access devices to be coupled and communicated with each other with electric wires of family housings.

In accordance with one aspect of the invention, there is provided a wire transmitting facility comprising a network access device for accessing into network systems, and including a first terminal and a second terminal, a transmitting device including an electric power supplier and an electric wire transmitting integrated circuit coupled to an electric power supply for receiving an electric power from the electric power supply. The electric wire transmitting integrated circuit is coupled to the second terminal of the network access device. The electric power supplier may be provided for converting the electric power from the electric power supply to a converted electric power, and coupled to the first terminal of the network access device for energizing the network access device, and coupled to the electric wire transmitting integrated circuit for energizing the electric wire transmitting integrated circuit. Both the network access device and the electric wire transmitting integrated circuit may be energized by the same electric power supply, such that the electric wire coupling between the WLAN access device and the transmitting device may be simplified, and the manufacturing cost for the wire transmitting facility may be decreased.

The electric wire transmitting integrated circuit includes a coupler coupled to the electric power supply for receiving electric power and information signals from the electric power supply and for sending information signals to the electric power supply.

The electric power supply includes a first electric line coupled to the coupler, for sending the electric power and the information signals to the coupler, and a second electric line coupled to the coupler for receiving the information signals from the coupler.

The electric wire transmitting integrated circuit includes a signal driving device coupled to the coupler, for amplifying the signals from the coupler.

The electric wire transmitting integrated circuit includes a converter coupled to the signal driving device for converting signals from the signal driving device to converted signals.

The electric wire transmitting integrated circuit includes an electric wire access control device coupled to the converter, and having a medium access control layer (MAC) for treating and processing the signals from the converter.

The electric wire access control device includes a physical layer for signal encoding and regulating purposes.

The electric wire transmitting integrated circuit includes a wireless transfer protocol control device coupled to the electric wire access control device for communicating with the network systems.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a block diagram illustrating a wire transmitting facility in accordance with the present invention for a local area network (LAN) or a WLAN system;

FIG. 2 is a block diagram illustrating the integrated circuit of the wire transmitting facility; and

FIG. 3 is a schematic view illustrating the operation or the coupling of two WLAN access devices with the wire transmitting facility and the electric wires of the family housings.

### DETAILED DESCRIPTION OF THE PREFERRED EMBODIMENT

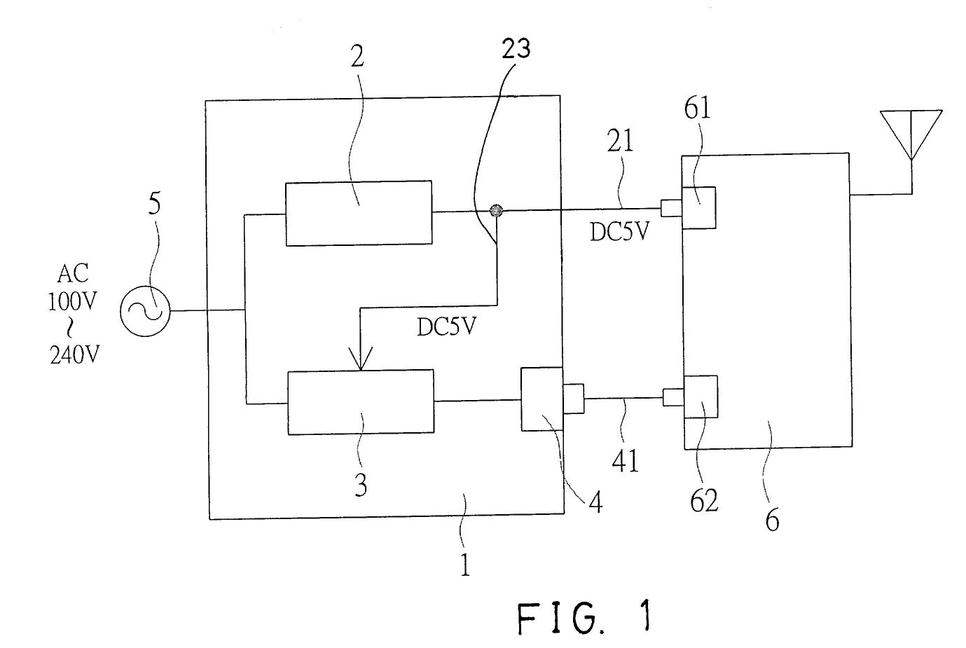

Referring to the drawings, and initially to FIG. 1, a wire transmitting facility in accordance with the present invention is illustrated and comprises a transmitting device 1 and a network access device 6, such as a wireless local area network (WLAN) access device 6 to be coupled together or to be coupled with each other. The WLAN access device 6 may be used for coupling to the internet or the other network systems.

The transmitting device 1 includes an electric power supplier, such as an alternate current (AC) electric power supplier 2, and an electric wire transmitting integrated circuit 3 coupled to an AC electric power source 5. The AC electric power supplier 2 may convert the AC electric power from the electric power source 5 to a direct current (DC) or a required or treated or converted electric power.

For example, the electric power supplier 2 may provide the DC electric power, such as the 5V DC electric power to a socket or a plug or a coupler or a terminal 61, such as an RJ-45 terminal of the WLAN access device 6, via a cable or an electric wire 21.

The electric power supplier 2 may further provide the DC electric power, such as the 5V DC electric power to the electric wire transmitting integrated circuit 3 via another cable or electric wire 23, such that both the electric wire transmitting integrated circuit 3 and the WLAN access device 6 may be energized by the same electric power supplier 2.

The transmitting device 1 includes a socket or a plug or a coupler or a terminal 4 coupled to the electric wire transmitting integrated circuit 3 and also coupled to another socket or plug or coupler or terminal 62 of the WLAN access device 6, with such as a cable or an electric wire 41.

It is to be noted that both the electric wire transmitting integrated circuit 3 and the WLAN access device 6 may be energized by the same electric power supplier 2, such that the wire coupling for the wire transmitting facility in accordance with the present invention may be greatly simplified, and the manufacturing cost for the wire transmitting facility may be decreased.

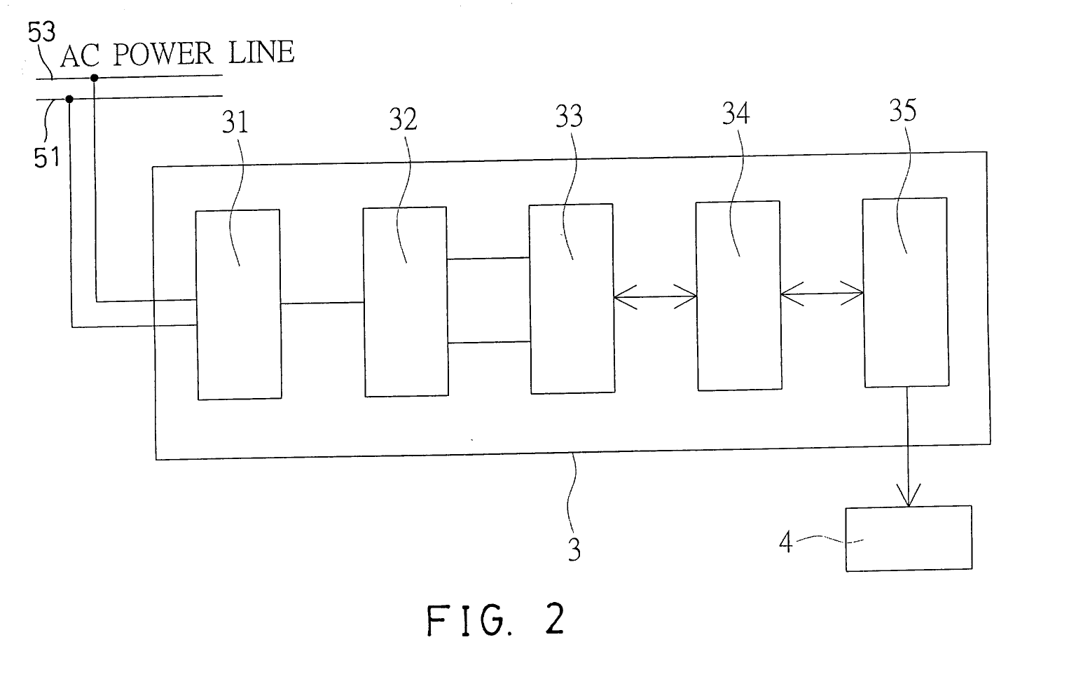

Referring next to FIG. 2, the electric wire transmitting integrated circuit 3 includes a coupler 31 coupled to the electric power source 5 via an electric cable or wire or line 51, for receiving both the electric power and information signals or messages from the electric line 51, and for sending treated information signals or messages to the electric line 51 or another electric line 52.

An analog signal driving device 32 is coupled to the coupler 31, for amplifying the signals from the coupler 31, and for facilitating the signal sending or receiving or transmitting in the electric wire transmitting integrated circuit 3.

A converter 33 is coupled to the driving device 32 for converting the signals from the driving device 32 to the other signals. For example, the converter 33 may be used to convert the analog signals from the driving device 32 to the digital signals; or, on the contrary, may be used to convert the digital signals from the driving device 32 to the analog signals

An electric wire access control device 34 is coupled to the converter 33, and includes a medium access control layer (MAC) for fetching or storing or treating or processing the signals from the converter 33. The electric wire access control device 34 further includes a physical layer for signal encoding or regulating purposes, such as for othogonal frequency division multiplexer (OFDM) purposes.

Another control device 35, such as a wireless transfer protocol control device 35 is coupled to the electric wire access control device 34 for providing information signals or messages that conformed to the institute of electrical and electronic engineers (IEEE) 802.3, and for communicating with the ethernet.

The wireless transfer protocol control device 35 is also coupled to the terminal 4 for coupling the electric wire access control device 34 to the terminal 4, which is then coupled to the terminal 62 of the WLAN access device 6, for allowing information signals or messages to be coupled or communicated between the WLAN access device 6 and the electric wire transmitting integrated circuit 3.

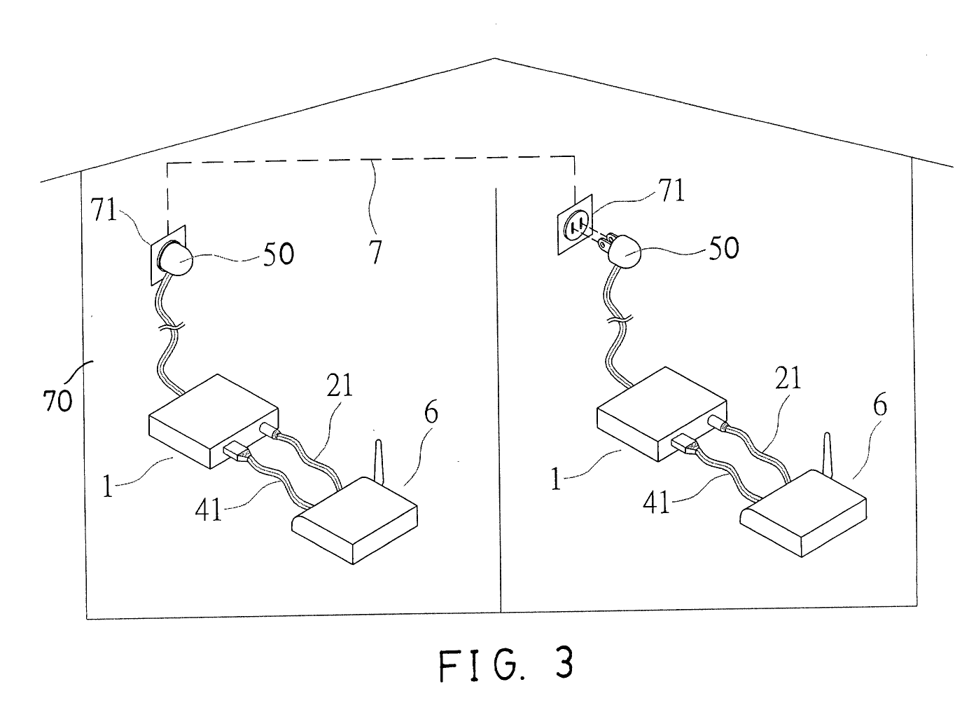

In operation, as shown in FIG. 3, two or more transmitting devices 1 may each be coupled to a WLAN access device 6 with electric wires 21, 41, and may each be coupled to the AC electric power source 5 of the family housing or building 70 with plugs or couplers 50 that may be coupled to the plugs or sockets or couplers 71 of the family housing or building 70.

As shown in dotted lines in FIG. 3, the plugs or sockets or couplers 71 of the family housing or building 70 may be coupled together with one or more inbuilt electric wires 7. The information signals or messages from or between the WLAN access devices 6 may thus be coupled or communicated with the electric wire transmitting integrated circuit 3 and the electric wires 7.

Once again, the electric power supplier 2 may provide the DC electric power, such as the 5V DC electric power to both the electric wire transmitting integrated circuit 3 and the WLAN access device 6, via the cables or electric wires 21, 23, for allowing both the electric wire transmitting integrated circuit 3 and the WLAN access device 6 to be energized to the same electric power supplier 2.

Accordingly, the wire transmitting facility in accordance with the present invention may be provided for coupling a WLAN access device to network systems with a single electric power source, and for simplifying the electric wire coupling of the WLAN access device, and for decreasing the manufacturing cost for the wire transmitting facility, and/or for allowing two or more WLAN access devices to be coupled and communicated with each other with electric wires of family housings.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A wire transmitting facility comprising:
a network access device for accessing into network systems, and including a first terminal and a second terminal,
a transmitting device including an electric power supplier and an electric wire transmitting integrated circuit coupled to an electric power supply for receiving an electric power from said electric power supply,
said electric wire transmitting integrated circuit being coupled to said second terminal of said network access device, and
said electric power supplier being provided for converting the electric power from said electric power supply to a converted electric power, and coupled to said first terminal of said network access device for energizing said network access device, and coupled to said electric wire transmitting integrated circuit for energizing said electric wire transmitting integrated circuit.

2. The wire transmitting facility according to claim 1, wherein said electric wire transmitting integrated circuit includes a coupler coupled to said electric power supply for receiving electric power and information signals from said electric power supply and for sending information signals to said electric power supply.

3. The wire transmitting facility according to claim 2, wherein said electric power supply includes a first electric line coupled to said coupler, for sending the electric power and the information signals to said coupler, and a second electric line coupled to said coupler for receiving the information signals from said coupler.

4. The wire transmitting facility according to claim 2, wherein said electric wire transmitting integrated circuit includes a signal driving device coupled to said coupler, for amplifying the signals from the coupler.

5. The wire transmitting facility according to claim 4, wherein said electric wire transmitting integrated circuit includes a converter coupled to said signal driving device for converting signals from said signal driving device to converted signals.

6. The wire transmitting facility according to claim 5, wherein said electric wire transmitting integrated circuit includes an electric wire access control device coupled to said converter, and having a medium access control layer (MAC) for treating and processing the signals from said converter.

7. The wire transmitting facility according to claim 6, wherein said electric wire access control device includes a physical layer for signal encoding and regulating purposes.

8. The wire transmitting facility according to claim 6, wherein said electric wire transmitting integrated circuit includes a wireless transfer protocol control device coupled to said electric wire access control device for communicating with the network systems.
